(19) United States
(12) Patent Application Publication
(10) Pub. No.: US 2011/0062700 A1
(43) Pub. Date: Mar. 17, 2011

(54) Pipe coupling and use thereof in joining molecularly oriented pipe

(75) Inventor: Bradford G. Corbett, JR., Fort Worth, TX (US)

(73) Assignee: S & B Technical Products, Inc., Fort Worth, TX (US)

(21) Appl. No.: 12/880,547

(22) Filed: Sep. 13, 2010

Related U.S. Application Data
(60) Provisional application No. 61/242,454, filed on Sep. 15, 2009.

(51) Int. Cl. F16L 21/00

(52) U.S. Cl. 285/31

(57) ABSTRACT

A method for joining molecularly oriented pipe in which a coupling is provided which is formed of a material other than molecularly oriented pipe, such as ordinary PVC pipe. The coupling if formed as a tubular body with a combination sealing and restraint mechanism located in each of two opposing end openings of the coupling that seal and restrain mating plain spigot ends of the molecularly oriented pipe. Because the coupling is made of a material such as ordinary PVC, the sealing and restraint mechanisms can be installed in internal grooves provided in the coupling interior during normal pipe belling operations without introducing unacceptable levels of stress or strain into the product.

### CROSS-REFERENCE TO RELATED APPLICATION

The present application claims priority from Provisional Application Ser. No. 61/242,454, filed Sep. 15, 2009, with the same title, by the same inventor.

### BACKGROUND OF THE INVENTION

1. Field of the Invention

The present invention relates generally to sealing systems for plastic pipe joints in which a male spigot pipe end is installed within a mating female socket pipe end, or in which two spigot pipe ends are installed within the opposing ends of a pipe coupling to form a continuous flow conduit.

2. Description of the Prior Art

Pipes formed from thermoplastic materials including polyethylene, polypropylene and PVC are used in a variety of industries. For example, such pipes are commonly used in municipal water and sewer applications. In forming a joint between sections of pipe, the spigot or male pipe end is inserted within the female or socket pipe end. The actual manufacture of the mating sections of plastic pipe typically involves the reforming of the end of the pipe by reheating and shaping to some desired profile to provide a means of mating with the opposing end of the next pipe. The art of forming sockets (also called bells) on plastics pipes is well established, and there are numerous processes and methods in the literature. An annular, elastomeric ring or gasket is typically seated within a grove formed in the socket end of the thermoplastic pipe. As the spigot is inserted within the socket, the gasket provides the major seal capacity for the joint.

In the early 1970's, a new technology was developed by Rieber & Son of Bergen, Norway, referred to in the industry as the “Rieber Joint.” The Rieber system employed a combined mold element and sealing ring for sealing a joint between the socket end and spigot end of two cooperating pipes formed from thermoplastic materials. In the Rieber process, the elastomeric gasket was installed within a simultaneously formed internal groove in the socket end of the female pipe during the pipe belling process. The provision of a prestressed and anchored elastomeric gasket during the belling process at the pipe factory provided an improved socket end for a pipe joint with a sealing gasket which would not twist or flip or otherwise allow impurities to enter the sealing zones of the joint, thus increasing the reliability of the joint and decreasing the risk of leaks or possible failure due to abrasion. The Rieber process is described in the following issued United States patents, among others: U.S. Pat. Nos. 4,120,521; 4,061,459; 4,030,872; 3,965,715; 3,929,958; 3,887,992; 3,884,612; and 3,776,682.

A newer form of plastic material used in plastic pipe manufacture is the so called “PVC Molecularly Oriented Pipe”, sometimes called “PVC-O pipe” or simply MOP for short. It is well established in the literature that molecular orientation of plastics can provide enhanced mechanical properties, and such materials are commonly used for plastics pipes. The molecularly oriented thermoplastic materials enhance the strength of the article in certain directions by orienting the molecules in the plastic material in such direction, whereby the tensile strength of the plastic increases and the stretch decreases in such direction. Applied to tubular articles, this orientation is effected in the radial direction, for instance to increase the pressure resistance of the pipe, or in the longitudinal direction of the pipe, for instance to increase the tensile strength of the pipe, or in both directions (biaxial orientation).

Orientation is achieved by drawing or stretching the material under appropriate conditions of temperature, such that a strain (i.e. deviation from the originally formed dimensions) is induced in the plastics material to cause alignment of the molecules, and thereafter cooling the material while drawn to lock in that strain. A number of methods have been proposed whereby this principle is applied to plastic pipes, in particular in order to enhance the burst strength under internal pressure by circumferential and/or axial forces.

For example, U.S. Pat. No. 4,428,900, shows a pipe of oriented thermoplastic polymeric material having an integral socket which is manufactured by expanding a tubular blank. The tubular blank is heated by circulation of hot water to a temperature at which deformation will induce orientation of the polymer molecules. The blank is then expanded radially outward against a mold by application of internal pressure.

U.S. Pat. No. 5,449,487, shows an apparatus and method for orienting plastic pipe. A heated pipe is oriented radially by means of a conically widening mandrel which is located downstream of the plastic extruder.

The above examples are intended merely to be illustrative of the general state of the art in the manufacture of molecularly oriented pipe.

However, despite these and similar advances in the pipe manufacturing arts, the reforming of oriented material can be problematical since, for example, the material will tend to revert if reheated. The oriented molecular structure, which is itself created by a deformation process, will be lost. Further, the deformation processes applied to the socket may alter the orientation level in such a way that the strength or other mechanical properties of the material are adversely affected.

Also, as has been mentioned, a sealing ring is typically used to seal the connection formed by insertion of the male pipe end into the enlarged female pipe end or socket. To accommodate this sealing ring, the socket will include an internal ring groove, typically formed by stretching the socket end over a specially-shaped mandrel enlarged about a circumferential location to form an annular groove that will house the sealing ring.

In the forming process, bending occurs at points of changes in direction of the surface, generating tensile or compressive strains in the material at that point. These strains add to or subtract from the strains generated in the orientation process and give rise to increased or decreased orientation. The bending stresses caused in formation of the ring groove have been found to modify the localized axial draw of the material in the vicinity of the ring groove, compared to the axial draw of the remainder of the socket. Thus, on the inside of the bend (i.e. the concave surface of the bend), the material of the ring groove is compressed (resulting in less axial draw), while on the outside of the bend (i.e. the convex surface of the bend) the axial draw will be increased. Along the neutral bending axis, extending approximately along the midpoint of the material section, the axial draw will be essentially unaltered. As a result, the stresses encountered during the belling operation can alter the desired properties of the molecularly oriented pipe.

To the best of Applicant's knowledge, molecularly oriented PVC pipe is currently being manufactured in nine countries and seventeen different cities using some six different technologies. As described briefly above, there exist many technological challenges inherent in stretching a PVC cylinder at a temperature slightly above its glass transition temperature to create PVC-o pipe. Forming the gasketed joint has proven to be the greatest challenge.

A search of the technical literature reveals publications by Uponor, Vinidex, Wavin, Alphacan, Pipelife and other companies currently involved in manufacturing PVC-O pipe. Despite the best efforts of these companies, producing gasketed bells on PVC-O pipe remains problematical. Problems exist with both the current batch manufacturing processes, as well as with the current continuous manufacturing processes. The batch processes of Uponor and Molecor have one set of technological challenges while the continuous processes of Vinidex, Alphacan, Wavin, etc., have their own set.

The batch production method can be viewed as having one advantage over the continuous method due to the fact the bell end is formed in the mold during the orientation process. Assuming the process conditions are correct to orient the PVC molecules in the pipe barrel, the bell will have proper orientation as well. However, this same advantage, forming the bell inside the same mold that forms the pipe, has its own disadvantage.

In any manufacturing process involving molding the greatest precision of the finished part is found on those surfaces where the part comes in contact with the mold. In the case of producing PVC-O using the batch process, the outside surfaces of the pipe barrel and bell end come in contact with the mold. While the outside surfaces are well formed their inside surfaces, including the inside surface of the gasket raceway, lack precision. Obviously the critical dimensions of the gasketed joint are found in the geometry of the gasket raceway. Poor raceway definition is endemic in batch process PVC-O and both sealing problems and field displacement problems can occur.

The continuous process has its own inherent problems. As has been briefly discussed, when PVC-O pipe is heated above its glass transition temperature it reverts. The OD shrinks, walls thicken, and orientation of the molecules is lost. Belling must be done at cold temperatures yet above the glass transition. Some studies have shown that the necessary belling temperature conditions result in a bell region not having the needed level of orientation.

Holding dimensions is difficult in both processes. As a result, the greatest contributor to production scrap is from the belling process. In the batch process a bell end is made at the end of every pipe. However, the inherent dimensional problems produce out-of-specification product. The continuous process suffers production scrap due to the necessary cold belling temperatures.

A need continues to exist, therefore, for improved techniques for manufacturing and joining MOP and specifically PVC-O pipe, which techniques take into account the unique properties of these types of molecularly oriented plastic materials.

### SUMMARY OF THE INVENTION

A coupling is shown for joining a first longitudinal section of molecularly oriented pipe to a second longitudinal section of molecularly oriented pipe, each of the longitudinal sections of molecularly oriented pipe having at least one plain, spigot end to be joined. The coupling is made up of a tubular body having an exterior surface, an interior surface and opposing ends with end openings which communicate with an initially open interior. A first combination seal and restraint mechanism is located within the interior of the tubular body adjacent one of the respective end openings thereof A second combination seal and restraint mechanism is located within the interior of the tubular body adjacent the other of the respective end openings. Each of the seal and restraint mechanisms includes both an annular sealing member and a companion gripping member for both sealing with and gripping and restraining a respective one of the molecularly oriented pipe spigot ends. The coupling tubular body is formed of a material other than molecularly oriented pipe. Preferably, the molecularly oriented pipe sections are formed of molecularly oriented PVC and wherein the tubular body is formed of plain PVC or reinforced PVC.

In one preferred form of the invention, the tubular body has a pair of internal grooves formed in the opposing ends thereof adjacent the respective end openings. Each of the combination seal and restraint mechanisms is located within a respective one of the internal grooves. The seal and restraint mechanisms each preferably include a grip housing for the gripping member and with the tubular body being formed over the sealing member and grip housing during manufacture of the tubular body.

In one particularly preferred form of the invention, a pipe joint is provided for joining a first longitudinal section of molecularly oriented pipe and a second longitudinal section of molecularly oriented pipe, each of the longitudinal sections of molecularly oriented pipe having at least one plain, spigot end for joining. A coupling is provided, as previously described, which receives and joins the first and second longitudinal sections of molecularly oriented pipe. In this particularly preferred form of the invention, each sealing and restraint mechanism includes a sealing ring formed as an elastomeric body, the sealing ring being integrally installed within a groove formed in a belled end of one end of the tubular body during the manufacture of the belled pipe end. A companion restraint mechanism for the elastomeric sealing ring allows movement of the spigot pipe end relative to the belled end of the female pipe in a first longitudinal direction but which restrains movement in a second, opposite relative direction.

The restraint mechanism in this case comprises a ring shaped housing which is also integrally installed within the belled pipe end during manufacture and which has a circumferential interior region and a companion gripping insert which is contained within the circumferential interior region of the housing. The gripping insert has an exterior surface and an interior gripping surface with at least one row of gripping teeth for gripping the spigot end of the molecularly oriented pipe. The gripping insert is conveniently provided as a ring shaped member having at least one circumferential slit in the circumference thereof which allows the gripping insert to be temporarily compressed and installed within the circumferential interior region of the housing in snap-fit fashion after the ring shaped housing has been integrally installed within the belled pipe end during manufacture of the tubular body of the coupling.

In the method of assembling a pipe joint of the invention, a coupling is provided as previously described. Each of the male spigot pipe ends of the molecularly oriented pipes is inserted, in turn, within the opposing end openings of the coupling until the coupling grips and seals against the spigot ends and forms a secure connection. The coupling can also be pre-mounted on one end of a section of MOP at the pipe manufacturing plant or at a field location for later assembly with another section of pipe in forming a pipeline.

Additional objects, features and advantages will be apparent in the written description which follows.

### BRIEF DESCRIPTION OF THE DRAWINGS

FIG. 1 is a partial, prospective view, partly broken away showing the pipe joint of the invention in which a special coupling has opposing female, belled ends, each of which receives a mating male spigot pipe end;

FIG. 2A is an isolated, quarter-sectional view of one of the belled pipe ends of the coupling of FIG. 1, showing the gripping and sealing mechanism located therein;

FIG. 2B is a side, cross-sectional view of one of the female socket ends of the coupling of FIG. 1 showing the insertion of male, spigot pipe end within the mouth opening of the coupling, where the coupling is FORMED of plain PVC and the male pipe end is formed of molecularly oriented material.

### DETAILED DESCRIPTION OF THE INVENTION

Plastic pressure pipe systems are used for the conveyance of drinking water, waste water, chemicals, heating and cooling fluids, foodstuffs, ultrapure liquids, slurries, gases, compressed air and vacuum system applications, both for above and below ground applications. Plastic pressure pipe systems have been in use in the United States for potable (drinking) water systems since at least about the 1950s. The types of plastic pipe in commercial use in the world today include, for example, acrylonitrile butadiene styrene (ABS), unplasticized polyvinyl chloride (UPVC), post chlorinated polyvinyl chloride, (CPVC), polypropylene (PP), polyethylene (PE), polyvinylidene fluoride (PVDF) and polybutylene (PB).

As discussed in the Background section above, a newer form of plastic material used in plastic pipe manufacture is the so called “PVC Molecularly Oriented Pipe”, sometimes called “PVC-O pipe” or simply MOP herein for simplicity. These molecularly oriented thermoplastic materials often exhibit enhanced strength of the article in certain directions by orienting the molecules in the plastic material in such direction, whereby the tensile strength of the plastic increases and the stretch decreases in such direction. This can provide advantages, for example when applied to tubular articles, where orienting is effected in the radial direction, for instance to increase the pressure resistance of the pipe, or in the longitudinal direction of the pipe, for instance to increase the tensile strength of the pipe, or in both directions (biaxial orientation).

A disadvantage of the molecularly oriented pipe (MOP), however, when used in such processes as the Rieber belling process, previously described, is that the MOP is difficult to bell. During the belling operation, as discussed above, the heated pipe end is forced over a forming mandrel which typically has a sealing ring, and perhaps other components, mounted about the mandrel. It is necessary to deform the heated pipe end as it passes over the forming mandrel and accommodates the sealing ring or other components. In some cases, the material of the MOP is already stretched to near its limit during pipe manufacture. The belling operation may fail when such MOP feedstock is used in a Rieber belling process, or at the very least, the otherwise desired properties of the MOP may be altered.

S&B Technical Products, Inc./Hultec, the assignee of the present invention, has previously developed specialized sealing gasket designs for PVC-O pipe. These designs are generally referred to as the PRESSURE FIX™, in Europe, and as the MAMBO® in North America. Although these gaskets have been shown to be effective sealing solutions for PVC-O in many instances, they can not directly affect the scrap issue faced by manufacturers of this product where MOP and particularly PVC-O pipe is not able to adequately withstand the stresses encountered during pipe belling operations.

The present invention offers a solution to the previously described problem with MOP by incorporating a unique sealing and restraint mechanism within a special “coupling” for the MOP. The sealing and restraint system, in one preferred form, is basically a BULLDOG® system of the type used in plastic pipe for the waterworks industry and in the BULLDOG® line of Horizontal Directional Drilling products. BULLDOG® is a registered trademark of S&B Technical Products, Inc., 1300 East Berry Street, Fort Worth, Tex. Essentially, a sealing and restraint mechanism of the type described in U.S. Pat. Nos. 7,537,248 and 7,328,493, is installed within a ring-shaped groove provided in each of two opposing end openings of a length of tubular coupling. The coupling is formed of a non-molecularly oriented plastic material. Since the coupling material is not oriented, manufacturing controls are easily held and specifications are easily met during the manufacture of the coupling. The couplings of the invention can be installed on plain end MOP before shipping, or shipped separately with the plain end pipe. Once the special coupling of the invention is installed on the end of a PVC-O pipe, its grip ring engages, and it is a fully functional gasketed bell end which is ready to be joined to an additional section of either plain plastic pipe, or MOP in forming a continuous pipeline or drill string.

It is possible to make a coupling having two Rieber gaskets and BULLDOG® grip rings, or two Rieber gaskets and one BULLDOG® grip ring. A double BULLDOG® coupling becomes joint restraint device, while a single BULLDOG® coupling becomes a standard Rieber gasketed bell end. The sealing and restraint function of the special coupling of the invention make it especially useful in drilling applications, such as horizontal directional drilling, where MOP is utilized as drill pipe. In the past, problems were encountered with the MOP sections pulling apart during drilling operations. Use of Applicant's special coupling allows MOP to be pushed or pulled, for example, in horizontal or trenchless drilling operations, without failure at the pipe joints.

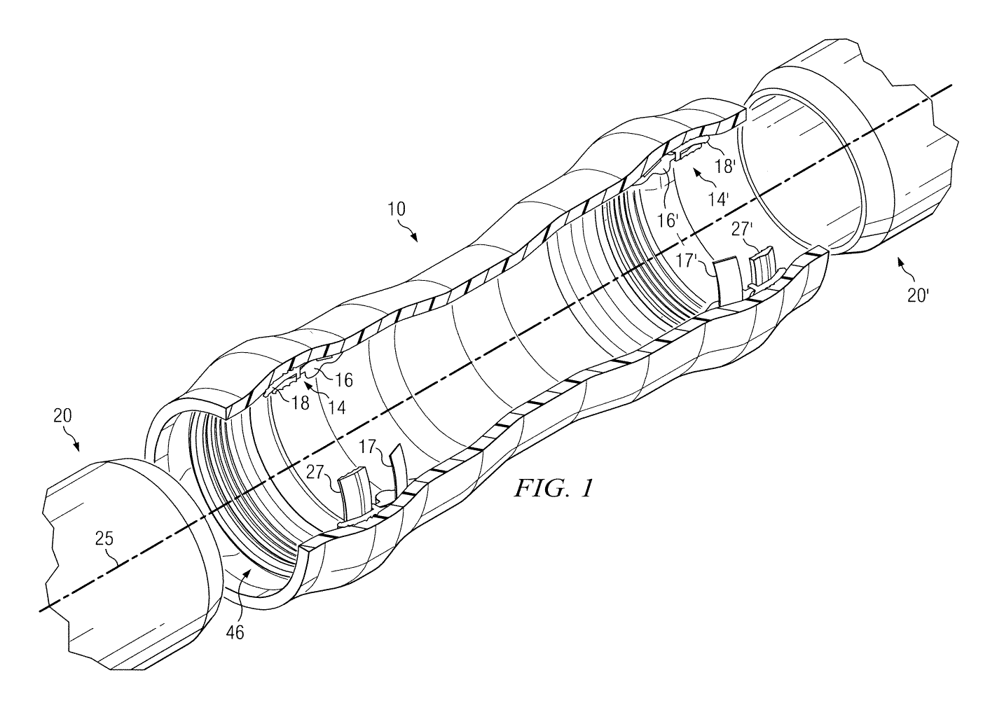

Turning now to FIG. 1 of the drawings, there is shown a special coupling of the invention, designated generally as 10. Each end of the coupling 10 is essentially a mirror image and the components thereof will be described with respect to a first end with the components of the second end being designated with primes.

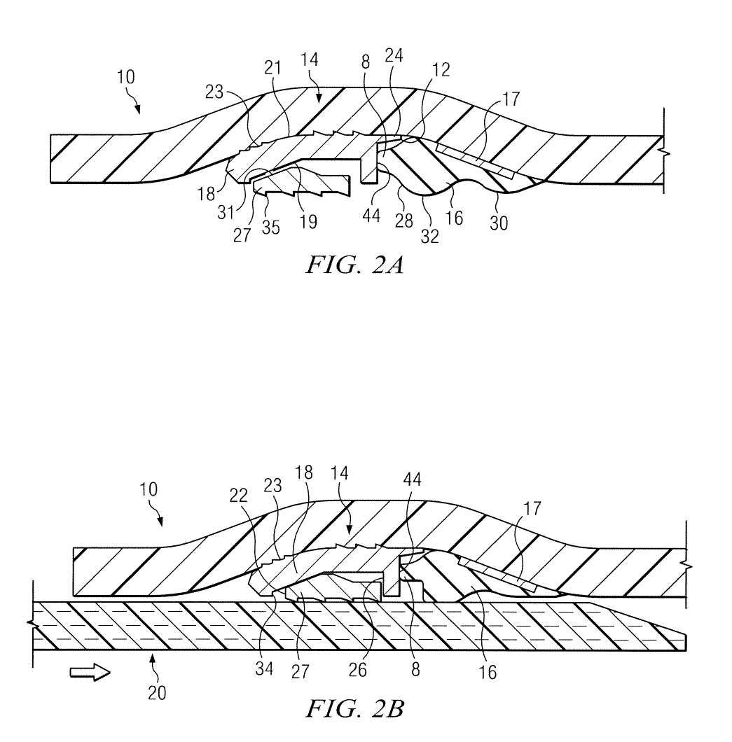

FIG. 1 is an exploded view of a plastic pipe coupling in which a first belled female pipe end is provided with an annular groove (shown as 12 in FIG. 2A) for receiving the BULLDOG® seal and restraint mechanism 14. The integral seal and restraint mechanism is capable of joining and sealing the tubular coupling 10 to the spigot end of a mating male MOP pipe section 20 having an exterior surface. It is important to note that while the male, spigot pipe ends 20, 20′ are formed of a molecularly oriented pipe material, that the coupling tubular body 10 is formed of a traditional plastic such as UPVC, or plain PVC which has been modified with impact modifiers, or the like. It is possible in some cases that the coupling tubular body might also be formed of another convenient synthetic material including the polyolefins such as polyethylene and polypropylene but in most cases, traditional rigid polyvinyl chloride will be utilized due to is cost and availability.

As best seen in FIGS. 1, 2A and 2B, the seal and restraint mechanism 14 includes an elastomeric, circumferential sealing ring 16 which is formed as an elastomeric body. The annular sealing ring 16 is somewhat tear drop shaped in cross section and includes a bulbous end region 28 (FIG. 2A) and a thinner forward most region 30. The bulbous end region 28 terminates in a nose portion 8. The sealing portion also has an exposed exterior region (generally at 32) which contacts the exterior surface 24 (FIG. 2B) of the mating spigot pipe end of the MOP upon assembly of the joint. The sealing member is preferably made of a resilient elastomeric or thermoplastic material. The sealing member can be formed, for example, from natural or synthetic rubber, such as SBR, or other elastomeric materials which will be familiar to those skilled in the plastic pipe arts such as EPDM or nitrile rubber. In this case, the sealing ring 16 has a metal reinforcing band 17 about the outer circumference thereof. However, as will be apparent from the description which follows, any number of specialized sealing rings can be utilized in order to optimize the sealing and restraining actions of the assembly.

The seal and restraint system which is utilized in the coupling of the invention also includes a companion restraint mechanism for the sealing ring 16 which allows movement of the mating male MOP spigot end (20 in FIG. 1) relative to the first belled end of the coupling 10 in a first longitudinal direction but which restrains movement in a second, opposite relative direction. The companion restraint mechanism includes a ring shaped housing 18 (FIG. 2A) having a circumferential interior region 19 and an exterior 21. The ring shaped housing provides radial stability and reinforcement for the male (spigot) pipe end of the MOP during make up of the joint so that the male pipe end 20 is radially supported during the joint assembly process. The exterior 21 extends from a nose region 22 (FIG. 2B) in convex fashion, gradually flattening out into a planar back region which terminates in a tip region 24. The tip region 24 serves as a protective skirt which covers any gap between the sealing ring 16 and ring shaped housing 18 during the pipe belling operation.

Although the housing could have a circumferential opening, it is preferably provided as a solid ring of a slightly larger internal diameter than the forming mandrel upon which it is received during pipe belling operations. Alternatively, the housing could be used with some form of collapsible forming mandrel, in which case its internal diameter might approach or exceed that of the mandrel in certain of its states of operation. The exterior 21 of the housing 18 may be equipped with one or more rows of gripping teeth 23 for engaging the surrounding coupling groove 12. The corresponding grooves or indentations in the coupling interior would be formed during the belling operation as the pipe cools. The ring shaped housing 18 is preferably formed of a material selected from the group consisting of metals, alloys, elastomers, polymeric plastics and composites and is rigid or semi-rigid in nature.

The leading portion of the circumferential interior region 19 is sloped upwardly with respect to the longitudinal axis (25 in FIG. 1) of the pipe. This leading portion 19 forms an upwardly sloping ramp surface for a companion gripping insert 27. The sloping ramp surface extends upwardly from a positive stop region (34 in FIG. 2B) and gradually flattens into a planar circumferential region which terminates in an internal shoulder (26 in FIG. 2B) arranged opposite an external shoulder 44. The positive stop region 34 prevents the companion gripping insert 27 from overly compressing the O.D. of the mating male MOP spigot end as the pipe joint is being assembled.

The housing external shoulder (44 in FIGS. 2A and 2B) is substantially perpendicular to the longitudinal axis 25 of the coupling. The external shoulder 44 is in contact with the nose region of the elastomeric body of the sealing ring 16 as the mating MOP spigot end is inserted into the mouth opening (46 in FIG. 1) of the coupling belled end. The housing and sealing ring can be provided as separate pieces, as shown in FIGS. 2A and 2B, or can be at least temporarily joined at a juncture point prior to the pipe belling operation. For example, a suitable glue or adhesive could be used to form a temporary juncture at the external shoulder 44 of the housing 18. In such case, the temporary juncture would typically be designed to be severed during the belling operation so that the sealing ring 16 and the housing 18 are separate at the time a pipe joint is made up in a field application. The housing 18 could also be integrated with the sealing ring 16, as during the curing of the elastomeric body of the ring.

FIGS. 2A and 2B illustrate the positioning of the companion ring-shaped gripping insert 27 which is received in complimentary fashion and contained within the circumferential interior region 19 of the housing 18. As shown in FIGS. 2A and 2B, the nose region 22 of the gripping insert 27 contacts the positive stop region 34 on the I.D. of the housing 18 in the forward most position to thereby assist in retaining the gripping insert within the housing. The gripping insert 27 has an exterior surface and an interior surface with at least one row of gripping teeth (35 in FIG. 2A). In the embodiment of the invention shown in FIGS. 2A and 2B, the gripping insert 27 actually has four rows of teeth. The rows of teeth are arranged for engaging selected points on the exterior surface of the mating MOP spigot pipe end 20.

The gripping insert exterior surface 31 has a sloping profile which contacts the upwardly sloping ramp surface of the housing 18, whereby contact with the exterior surface of the MOP causes the gripping insert 27 to ride along sloping profile at an angle while the row of gripping teeth on the gripping insert internal surface engage the exterior surface of the MOP spigot pipe end. The rows of teeth 35 on the lower surface of the ring shaped insert 27 can be of equal length or can vary in length and can be arranged in either a uniform or non-uniform pattern about the inner circumference of the gripping insert. The teeth of the gripping insert are also angled away from the horizontal axis of the joint (25 in FIG. 1) at an angle of less than 90°. As will be appreciated from the drawings, the gripping insert will typically be provided as a slit ring having a single slit in the circumference thereof. The gripping insert 27 is a rigid or relatively rigid member. By “relatively rigid” is meant that the gripping insert 27 can be formed of a hard metal, such as corrosion resistant stainless steel, or from other metallic materials or alloys or even a hardened plastic or composite. The slit in the circumference allows the insert 27 to be compressed and snap-fit into the interior of the surrounding housing after the housing has been installed during the belling operation.

FIG. 2A and 2B illustrate the make-up of a joint of plastic pipe in which the male spigot end 20 formed of MOP material is inserted within the first belled end of the coupling 10 of the invention. FIG. 2B illustrates the gripping action of the rows of teeth 35 of the gripping insert in which the teeth grip the exterior surface 24 of the MOP spigot pipe end 20. The rows of teeth 35 are angled inwardly with respect to the axis 25 so that contact with the male pipe end (20 in FIG. 2B) causes the teeth to be deflected in a counterclockwise direction with respect to axis 25 during the insertion step, as viewed in FIG. 2B. Once the male pipe section 20 has been fully inserted, the rows of teeth 35 grip the exterior surface of the male pipe and resist movement in an opposite longitudinal direction. The nose region 8 of the sealing ring 16 also contacts and forms a sealing region with respect to the external shoulder 44 of the housing 18.

The Rieber process, which will typically be used to form the coupling 10 of the invention has been briefly described. In the Rieber process, the elastomeric gasket is installed within a simultaneously formed internal groove in the socket end of the female pipe during the pipe belling process. The provision of a prestressed and anchored elastomeric gasket during the belling process at the pipe factory provides an improved socket end for a pipe joint with a sealing gasket which will not tend to twist or flip or otherwise allow impurities to enter the sealing zones of the joint, thus increasing the reliability of the joint and decreasing the risk of leaks or possible failure due to abrasion.

While the Rieber process provided an integral sealing gasket which was “prelocated” within the belled, female pipe end in a groove which was formed about the gasket, it did not provide any mechanical “restraining function” to prevent separation of the male and female pipe ends at the pipe connection once the pipe joint was made up. Applicant's BULLDOG® seal and restraint mechanism differs from the above described Rieber process in that it serves to provide both sealing and restraining functions.

The method of installing the components of the restraining system of the invention will now be briefly described. In the preferred method of installation, the sealing ring (16 in FIG. 2A) and ring shaped housing 18 are placed side by side on the forming mandrel (such as described in U.S. Pat. Nos. 7,537,248 and 7,328,493) and the first female coupling end is heated and belled over these components in the normal fashion, as has been described with respect to the Rieber process. The backup collar position or the mandrel seating groove location and size may have to be adjusted for the resulting changes in bell dimensions, i.e., to allow enough room for the housing 18. Once the first coupling belled end has been cooled and the forming mandrel has been retracted, the second coupling end can be belled in similar fashion. The gripping inserts 27 can be snapped or popped into position on the inner circumference of the respective housings 18, as shown in FIG. 2A.

An invention has been provided with several advantages. The present invention provides a sealing and restraint system in a special coupling for joining MOP in which the restraint mechanism is integral to the groove formed in the bell end openings of the coupling. The restraining mechanism may be provided as a part of a “gasket formed” bell groove, as in a Rieber style pipe belling operation where the groove is simultaneously formed as the bell pipe end is formed. Since the tubular body of the coupling is formed of a non-molecularly oriented plastic material, it can be handled in the traditional manner during the Rieber style belling operation. Since the coupling material is not oriented, manufacturing controls are easily held and specifications are easily met during pipe manufacture. The couplings of the invention can be installed on plain end MOP before shipping, or shipped separately with the plain end pipe. It is possible to make a coupling having two Rieber gaskets and BULLDOG® grip rings, or two Rieber gaskets and one BULLDOG® grip ring. A double BULLDOG® coupling becomes joint restraint device, while a single BULLDOG® coupling becomes a standard Rieber gasketed bell end.

Because of the inherent restraint function achieved by the coupling of the invention, it can advantageously be utilized in drilling applications for plastic drill pipe, such as in horizontal directional drilling, or “trenchless drilling”, where MOP is utilized as drill pipe. In the past, problems were encountered with the MOP sections pulling apart during drilling operations, in part due to the difficulties presented by the nature of the MOP. The use of the coupling of the invention overcomes many of these difficulties.

While the invention has been shown in only one of its forms, it is not thus limited but is susceptible to various changes and modifications without departing from the spirit thereof

What is claimed is:

1. A coupling for joining a first longitudinal section of molecularly oriented pipe to a second longitudinal section of molecularly oriented pipe, each of the longitudinal sections of molecularly oriented pipe having at least one plain, spigot end, the coupling comprising:
a tubular body having an exterior surface, an interior surface and opposing ends with end openings which communicate with an initially open interior, a first combination seal and restraint mechanism located within the interior of the tubular body adjacent one of the respective end openings thereof, a second combination seal and restraint mechanism located within the interior of the tubular body adjacent the other of the respective end openings, each of the seal and restraint mechanisms including both an annular sealing member and a companion gripping member for both sealing with and gripping and restraining a respective one of the molecularly oriented pipe spigot ends; and
wherein the tubular body is formed of a material other than molecularly oriented pipe.

2. The coupling of claim 1, wherein the molecularly oriented pipe sections are formed of molecularly oriented PVC and wherein the tubular body is formed of plain PVC or reinforced PVC.

3. The coupling of claim 2, wherein the tubular body has a pair of internal grooves formed in the opposing ends thereof adjacent the respective end openings, each of the combination seal and restraint mechanisms being located within a respective one of the internal grooves.

4. The coupling of claim 3, wherein the seal and restraint mechanisms each include a grip housing for containing a gripping ring and wherein the tubular body is formed over the sealing member and grip housing during manufacture of the tubular body.

5. A pipe joint, comprising:
a first longitudinal section of molecularly oriented pipe and a second longitudinal section of molecularly oriented pipe, each of the longitudinal sections of molecularly oriented pipe having at least one plain, spigot end;
a coupling which receives and joins the first and second longitudinal sections of molecularly oriented pipe, the coupling comprising a tubular body having an exterior surface, an interior surface and opposing ends with end openings which communicate with an initially open interior, a first combination seal and restraint mechanism located within the interior of the tubular body adjacent one of the respective end openings thereof, a second combination seal and restraint mechanism located within the interior of the tubular body adjacent the other of the respective end openings, each of the seal and restraint mechanisms including both an annular sealing ring and a companion gripping ring for both sealing with and gripping and restraining a respective one of the molecularly oriented pipe spigot ends as the spigot ends are inserted within the coupling; and
wherein the tubular body is formed of a material other than molecularly oriented pipe.

6. The pipe joint of claim 5, wherein the molecularly oriented pipe sections are formed of molecularly oriented PVC and wherein the tubular body is formed of plain PVC or reinforced PVC.

7. The pipe joint of claim 6, wherein the tubular body has a pair of internal grooves formed in the opposing ends thereof adjacent the respective end openings, each of the combination seal and restraint mechanisms being located within a respective one of the internal grooves.

8. The pipe joint of claim 7, wherein the seal and restraint mechanisms each include a grip housing for the gripping ring and wherein the tubular body is formed over the sealing ring and gripping ring housing during manufacture of the tubular body.

9. A pipe joint, comprising:
a first longitudinal section of molecularly oriented pipe and a second longitudinal section of molecularly oriented pipe, each of the longitudinal sections of molecularly oriented pipe having at least one plain, spigot end;
a coupling which receives and joins the first and second longitudinal sections of molecularly oriented pipe, the coupling comprising a tubular body having an exterior surface, an interior surface and opposing ends with end openings which communicate with an initially open interior, a first combination seal and restraint mechanism located within the interior of the tubular body adjacent one of the respective end openings thereof, a second combination seal and restraint mechanism located within the interior of the tubular body adjacent the other of the respective end openings;
wherein each sealing and restraint mechanism includes a sealing ring formed as an elastomeric body, the sealing ring being integrally installed within a groove formed in a belled end of one end of the tubular body during the manufacture of the belled pipe end;
a companion restraint mechanism for the elastomeric sealing ring which allows movement of the spigot pipe end relative to the belled end of the female pipe in a first longitudinal direction but which restrains movement in a second, opposite relative direction, the restraint mechanism comprising a ring shaped grip housing which is also integrally installed within the belled pipe end during manufacture and which has a circumferential interior region and a companion gripping insert which is contained within the circumferential interior region of the grip housing, the gripping insert having an exterior surface and an interior gripping surface with at least one row of gripping teeth;
wherein the tubular body is formed of a material other than molecularly oriented pipe.

10. The pipe joint of claim 9, wherein the gripping insert is a ring shaped member having at least one circumferential slit in the circumference thereof which allows the gripping insert to be temporarily compressed and installed within the circumferential interior region of the grip housing in snap-fit fashion after the ring shaped grip housing has been integrally installed within the belled pipe end during manufacture of the tubular body of the coupling.

11. The pipe joint of claim 10, wherein the molecularly oriented pipe sections are formed of molecularly oriented PVC and wherein the tubular body is formed of plain PVC or reinforced PVC.

12. A method of coupling a first longitudinal section of plain end, molecularly oriented plastic pipe to a second longitudinal section of plain end, molecularly oriented plastic pipe, where each of the sections of molecularly oriented pipe has at least one plain, spigot end, the method comprising the steps of:
providing a coupling which receives and joins the first and second longitudinal sections of molecularly oriented pipe, the coupling comprising a tubular body having an exterior surface, an interior surface and opposing ends with end openings which communicate with an initially open interior, a first combination seal and restraint mechanism located within the interior of the tubular body adjacent one of the respective end openings thereof, a second combination seal and restraint mechanism located within the interior of the tubular body adjacent the other of the respective end openings, each of the seal and restraint mechanisms including both an annular sealing ring and a companion gripping ring for both sealing with and gripping and restraining a respective one of the molecularly oriented pipe spigot ends as the spigot ends are inserted within the coupling;
forming the pipe joint by inserting, in turn, a selected spigot pipe end of the first and second sections of molecularly oriented pipe within a respective one of the end openings of the coupling; and
wherein the tubular body is formed of a material other than molecularly oriented pipe.

13. The method of claim 12, wherein the molecularly oriented pipe sections are formed of molecularly oriented PVC and wherein the tubular body is formed of plain PVC or reinforced PVC.

14. The method of claim 13, wherein the tubular body has a pair of internal grooves formed in the opposing ends thereof adjacent the respective end openings, each of the combination seal and restraint mechanisms being located within a respective one of the internal grooves.

15. The method of claim 14, wherein the seal and restraint mechanisms each include a grip housing for the gripping ring and wherein the tubular body is formed over the sealing ring and grip housing during manufacture of the tubular body.
